(19) United States
(12) Patent Application Publication
(10) Pub. No.: US 2025/0323352 A1
(43) Pub. Date: Oct. 16, 2025

(54) HYBRID FC-BATTERY SYSTEM WITHOUT POWER ELECTRONICS

(71) Applicant: ZeroAvia, Inc., Hollister, CA (US)

(72) Inventors: Gabriel DeVault, Hollister, CA (US); Michael Dana Sarnoff-Wood, Hollister, CA (US)

(21) Appl. No.: 18/637,316

(22) Filed: Apr. 16, 2024

(51) Int. Cl. H01M 16/00; B60L 1/00; B60L 50/70; H01M 10/0525; H01M 10/06; H01M 10/34

(52) U.S. Cl. CPC H01M 16/006; B60L 1/00; B60L 50/70; H01M 10/0525; H01M 10/06; H01M 10/345; B60L 2200/10; H01M 2220/20; H01M 2250/20; H01M 2250/402

(57) ABSTRACT

A DC-DC converter-free hybrid fuel cell (PC)-energy storage (ES) system (FC-ES) is used for powering an electric device, wherein the PC and ES are electrically connected and configured so that the PC and ES intrinsically absorb and control system transients through state-of-charge cross-overs. The electric device preferably is a vehicle, and in particular a hydrogen fuel-cell-powered aircraft.

### TECHNICAL FIELD

The present disclosure relates to hydrogen fuel cell power systems for powering electronic devices such as vehicles, including aircraft, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Exhaust emissions from transport vehicles are a significant contributor to climate change. Conventional fossil-fuel-powered aircraft engines release CO₂ emissions. Also, fossil-fuel-powered aircraft emissions include non-CO₂ effects due to nitrogen oxide (NOx), vapor trails, and cloud formation triggered by the altitude at which aircraft operate. These non-CO₂ effects are believed to contribute twice as much to global warming as aircraft CO₂ and are estimated to be responsible for two-thirds of aviation's climate impact. Additionally, the high-speed exhaust gasses of conventional fossil-fuel-powered aircraft engines contribute significantly to the extremely large noise footprint of commercial and military aircraft, particularly in densely populated areas.

Rechargeable battery-powered terrestrial vehicles, i.e., “EVs”, are slowly replacing conventional fossil-fuel-powered terrestrial vehicles. However, the weight of batteries and limited energy storage of batteries makes rechargeable battery-powered aircraft generally impractical.

Hydrogen fuel cells (FCs) offer an attractive alternative to fossil-fuel-burning engines. Hydrogen FC tanks may be quickly filled and store significant energy and, other than the relatively small amount of unreacted hydrogen gas, the reaction output exhausted from hydrogen FCs comprises essentially only water.

An FC is an electrochemical device that includes an anode and a cathode with an electrolyte therebetween. The anode receives hydrogen gas, and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte and thus are directed through a load to perform work before being sent to the cathode. The work acts to operate the vehicle.

Proton exchange membrane fuel cells (PEMFC) are a popular FC for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture, and the membrane define a membrane electrode assembly (MEA). MEAs are relatively expensive to manufacture and require certain conditions for effective operation. These conditions include proper water management and humidification as well as control of catalyst poisoning constituents, such as carbon monoxide (CO).

Several FCs are typically combined in an FC stack to generate the desired power. The FC stack receives a cathode input gas, typically a flow of air forced through the stack by a compressor. Not all of the oxygen is consumed by the stack, and some of the air is output as a cathode exhaust gas that may include water as a stack by-product. The FC stack also receives an anode hydrogen input gas that flows into the anode side of the stack.

Typical FC EVs have a hybrid FC-battery system that employs a supplemental power source in addition to the fuel cell stack, such as a DC battery. The supplemental power source may also take the form of a super capacitor as will be discussed below. The supplemental power source provides supplemental power for the various vehicle auxiliary loads, for system start-up, and during high power demands when the FC stack is unable to provide the desired power. High power demands are particularly challenging in the case of FC-powered aircraft during take-off and climb. The FC stack provides power to a traction motor through a DC voltage bus line for vehicle operation. The supplemental power source provides supplemental power to the voltage bus line during those times when additional power is needed beyond what the stack can provide, such as during heavy acceleration. For example, the FC stack may provide 70 kW of power whereas vehicle acceleration may require 100 KW of power. The FC stack is used to recharge the supplemental power source at those times when the FC stack is able to provide the system power demand. In the case of a motor vehicle, the generator power available from the traction motor during regenerative braking is also used to recharge the supplemental power source.

In prior art, such as the hybrid vehicles discussed above, the supplemental power source is coupled to the motor controller in series, and a FC charges the supplemental power source through a DC-DC converter system. A bi-directional DC-DC converter typically is necessary to step up the DC voltage from the battery to match the battery voltage to the bus line voltage dictated by the voltage output of the FC stack and step down the stack voltage during battery recharging.

In the case of typical FC EVs having a hybrid FC-battery system, the battery is coupled to the motor controller in series, and the FC charges the battery through the DC-DC converter. This allows the battery to absorb high power and transients that the FC could not handle. However, the power electronics associated with a DC-DC converter add system complexity and may contribute 10-30% to the system weight, which is significant considering that existing DC-DC converters for a 100 kW FC may be 30 kg each and require cooling elements which make the vehicle suffer additional weight and drag.

There have been various attempts in the industry to eliminate DC-DC converters in FC EVs by providing a power source that is able to handle the large voltage swing coming from the FC stack with its V/I characteristic (polarization curve) over the operating conditions of the vehicle. In one known system, a super-capacitor is used as the supplemental power source. However, a super-capacitor is limited by how much it can be discharged because of its low energy content. Also, a super-capacitor requires a power device to ramp up the super-capacitor voltage at system start-up. Certain types of batteries have also been used to eliminate the DC-DC converters in FC EV systems. However, these systems were limited by the ability to discharge the battery beyond a certain level since these types of batteries would be damaged as a result of large voltage swings on the DC bus line during the operation of the system.

The foregoing discussion of the prior art derives primarily from US Published Application 2006/0238033 A1, which describes a FC system that employs a battery that matches the battery voltage to a power bus line voltage to eliminate the need for a DC-DC converter. The internal characteristics and parameters of the matched battery reportedly allow it to operate over a large voltage discharge swing as dictated by the FC V/I characteristic and prevent the battery from being over-discharged. The battery type, number of battery cells, and the battery internal impedance are designed to provide the desired matching. In one embodiment according to US 2006/0238033 A1, the battery is a lithium-ion battery. The system also includes a diode electrically coupled to the power bus line and a bypass switch electrically coupled to the bus line in parallel with the diode. The bypass switch is selectively opened and closed to allow the FC stack to recharge the battery and prevent the battery from being overcharged.

The prior art also proposes providing stack-to-pack (FC stack, battery pack) designs with connections between the FC and battery to minimize power electronics, as well as flexibility of stack variation topologies and battery types, e.g., lead-acid (Pb-acid), nickel-metal hydride (NMH), nickel manganese cobalt (NMC), and lithium-ion (Li-ion). However, with such prior art systems, there is still a challenge with protection of electrochemical devices.

In accordance with the present disclosure, we provide a hybrid electrochemical energy storage (ES-battery) FC system that is electrically connected to regulate voltage and high-power demands intrinsically. Namely, the proposed invention is a hybrid between stack-to-pack and cell-to-pack (FC cell, battery pack) designs, driven by the electrochemical potential gradient from different states-of-charge (SoC) in the different batteries, whereby to eliminate the need for DC-DC connectors and the power electronics associated with DC-DC converters.

That is to say, we provide a hybrid FC-ES battery system that is electrically connected so that the FC-ES system regulates voltage and high-power demands intrinsically, driven by the electrochemical potential gradient from different SoC in the different batteries.

The elimination of DC-DC converters and associated power electronics enables simpler, lower-cost electrical connections and lighter, smaller, more efficient, and more reliable motor trains for EVs, including aircraft, that incorporate FCs. FC-powered aircraft in accordance with the present disclosure may also be easier to certify since they run on simple electro-chemo-mechanical principles without the use of additional electronics and software.

By matching the characteristics of the FC and ES battery cells, the combined assembly may handle higher currents and faster transients than the FC alone could handle without requiring additional electronics or software. The ES battery will naturally charge and discharge as needed, and inherent to, the physical and electrochemical characteristics engineered into the individual ES battery cells.

In one embodiment of the disclosure, open circuit and loaded voltages are matched by ES cell count and chemistry, such that the FC charges the ES battery when current demand is low, and the ES battery provides excess power required above what the FC normally provides when current demand is high. Driven by the SoC of the battery and with matching of individual FCs and ES battery cells, the need for DC-DC converters is eliminated or at least minimized.

The present disclosure's ES-to-FC cell-to-cell design also may prevent current backflow that, prior to the present disclosure, typically was addressed using thyristors or backing diodes, which also adds to cost, weight, and complexity of the system and also provides another potential point of failure.

In one embodiment, individual ES battery cells (typically Pb-acid batteries, NMH batteries, or Li-ion batteries) are connected to either single, double, or quadruple FCs to match complete FC stack voltage.

In one embodiment, each ES battery cell buffers each FC stack cell individually and helps to level the FC stack cell voltages and prevent an FC stack cell from sagging excessively, which has the potential to improve reliability and lifetime performance of the FC stack cells by ensuring they are continuously in an ideal operating regime. For example, if an FC system is run down to 0.5V/cell, per-cell buffering may allow an individual FC stack cell to survive long enough to clear itself from, e.g., water contamination.

In another embodiment, SoC cross-over points (between FC and ES battery-dominated voltage) that are above the 50% SoC (upper left of discharge curves) may be particularly suitable for applications such as aircraft, where the FC benefits from being heavily augmented with ES battery power during periods of high demand, e.g., takeoff and climb.

More particularly, in accordance with one aspect of the disclosure there is provided a DC-DC converter-free hybrid fuel cell (FC)-energy storage system (FC-ES) for powering an electric device, wherein the FC and ES are electrically connected through a hybrid configuration between stack-to-pack and cell-to-pack configurations.

In one aspect the FC and ES are configured to intrinsically absorb and control system transients through SoC cross-over points.

In one aspect the FC and ES are connected in parallel.

In another aspect the hybrid FC-ES system comprises a plurality of series connected FCs parallel connected to the ES.

In another aspect, quadruple series connected FCs are parallel connected to a single ES.

In a further aspect, quadruple series connected FCs are parallel connected to plural ESs.

In a still further aspect double series connected FCs are parallel connected to a single ES.

In yet another aspect double series connected FCs are parallel connected to double ESs.

In one aspect the ES comprises a lithium-ion battery.

In another aspect the ES battery comprises a Pb-acid battery.

In still yet another aspect the ES battery comprises a nickel-metal hydride (NMH) battery.

In a further aspect the ES battery comprises a nickel manganese cobalt (NMC) battery.

In another aspect the FC comprises a hydrogen FC.

The present disclosure provides an electric device powered by the hybrid FC-ES system as above described.

In one aspect the device comprises an FC-ES-powered vehicle.

In another aspect the vehicle comprises a hydrogen FC powered vehicle.

In a further aspect the FC-ES-powered vehicle comprises an aircraft.

In yet a further aspect the vehicle comprises a hydrogen FC powered airplane.

In a still further aspect the device comprises a portable device.

In yet another aspect the portable device comprises a personal electronic device.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1A schematically illustrates a hybrid single array quadrupole (hydrogen) FC-single (NMC battery) ES system in accordance with the present disclosure;

FIG. 1B schematically illustrates a hybrid FC-ES multi array system in accordance with the first embodiment of the present disclosure shown in FIG. 1A;

FIG. 2 schematically illustrates a hybrid FC-ES system comprising a hybrid FC-ES system multi array with a double (hydrogen) FC—double (NMH battery) ES design in accordance with a second embodiment of the present disclosure;

FIG. 3A schematically illustrates a hybrid FC-ES system single array with a single (hydrogen) FC—single (NiCad/NiMH battery) ES design in accordance with a third embodiment of the present disclosure;

FIG. 3B schematically illustrates a hybrid FC-ES multi array system in accordance with the third embodiment of the present disclosure shown in FIG. 3B;

FIG. 4 graphically plots FC and ES pack discharge voltage against SoC over an array of hybrid FC-ES chemistry and electrical configurations in accordance with embodiments of the present disclosure;

FIG. 5 graphically plots discharge voltage vs. SoC curves of a hybrid quadruple FC and single lithium-ion battery pack array in accordance with an embodiment of the present disclosure;

FIG. 6 graphically plots discharge voltage vs. SoC curves for a hybrid double FC-single ES battery arrays in accordance with yet another embodiment of the present disclosure;

FIG. 7 graphically plots discharge voltage vs. SoC for a hybrid FC-ES pack array in accordance with another embodiment of the present disclosure, highlighting the region of the FC charging the ES vs the region of ES supplementing the FC; and

FIG. 8 is a schematic view of a FC-powered aircraft including a hybrid FC-ES system in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

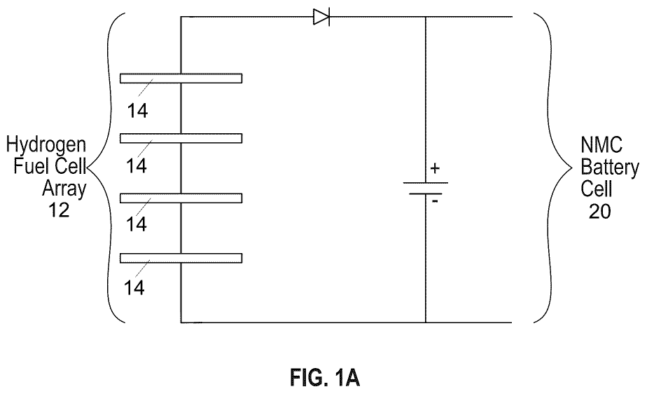

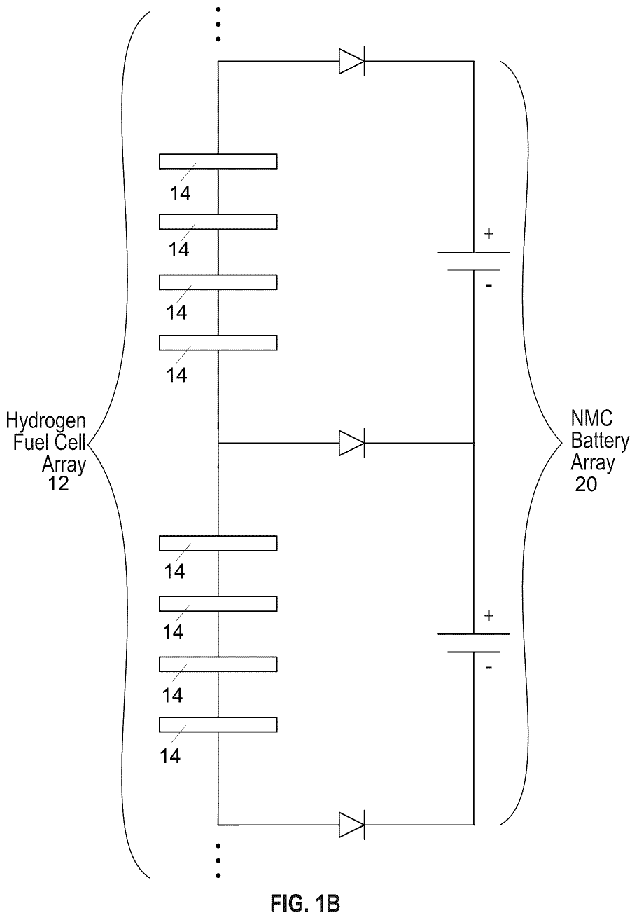

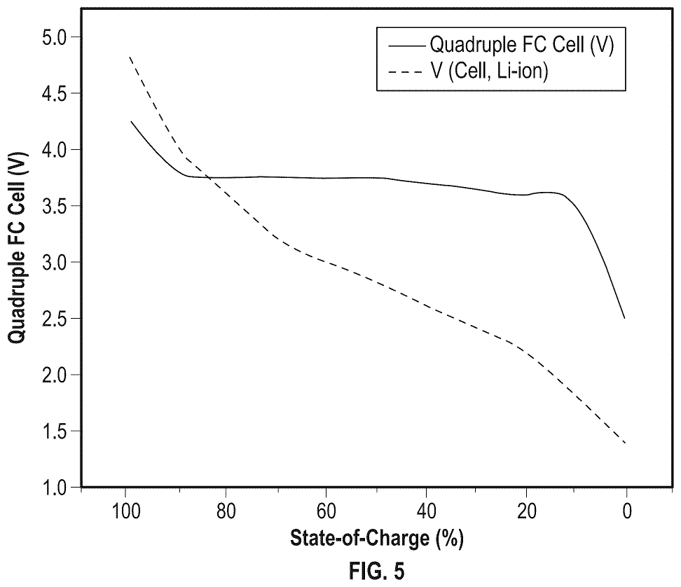

Referring to FIG. 1A, there is illustrated a hybrid FC-ES array in accordance with a first embodiment of the present disclosure. The FC-ES array comprises four series connected hydrogen FCs connected in parallel with a single Li-ion (NMC) battery. The FC-ES system illustrated in FIG. 1A has a discharge curve illustrated in FIG. 5, where the cross-over point is at about 85% SoC and 3.7 V. Thus, above 3.7V, the battery is providing the voltage while below 3.7V, the FC is providing nearly constant voltage for the majority of the hybrid FC-ES system operation. In the case of incorporating the hybrid FC-ES system of the present disclosure in a device or vehicle, multiple single arrays would be used, as illustrated in FIG. 1B, comprising two quadruple series connected FCs connected in parallel with an array of two NMC batteries and other connected cells implied to extend out.

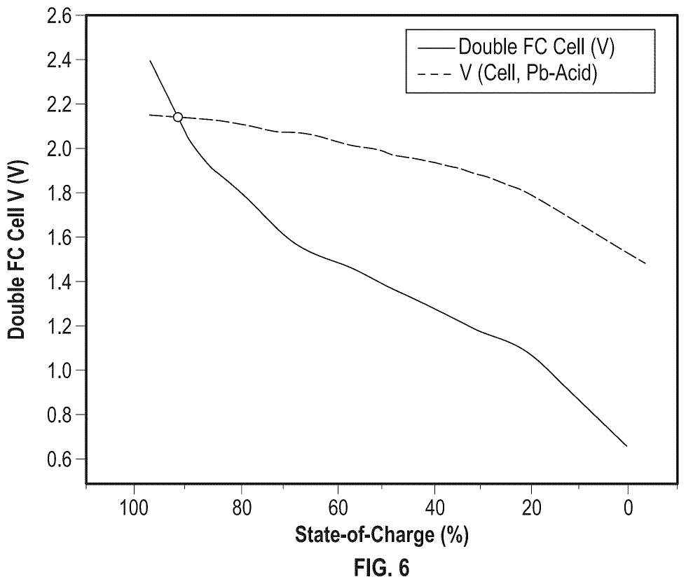

Another example of a hybrid FC-ES system in accordance with the present disclosure (electrical connection schematic not illustrated) comprises two series connected FCs connected in parallel with one Pb-acid battery. The discharge curve of this embodiment is shown in FIG. 6, where the SoC cross-over point is at about 90% SoC and 2.1V.

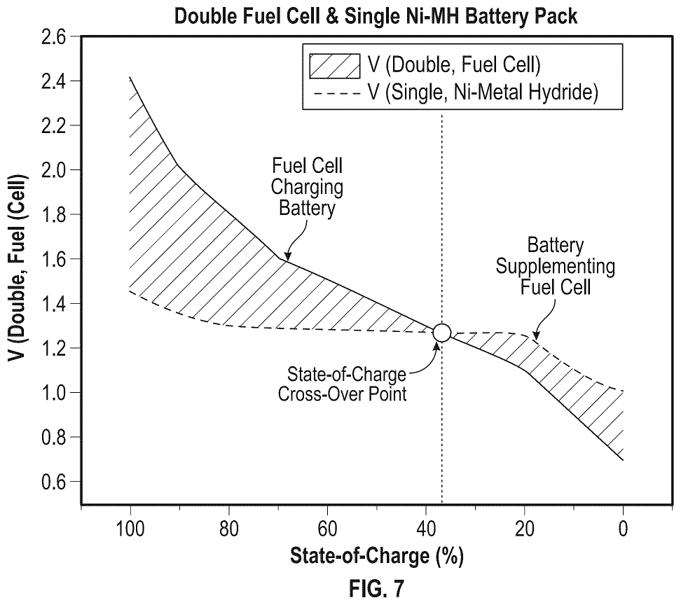

SoC cross-over points (i.e., the point at which the SoC of the FC falls to the level of the battery voltage) that are below the 50% SoC (upper left of discharge curves) are most suitable for steady-state applications such as personal electronics or other portable electronics applications, where it is preferred to maintain higher SoC on the battery and less extreme cycling. For example, by providing a series connected double FC connected in parallel to a single NMH ES (electrical schematic not shown), we can obtain an SoC cross-over point of near 40% and 1.3 V and a maximum system voltage is 2.4 V. See FIG. 7. This is a case that provides an especially efficient possible electrical hybrid combination by completely eliminating any DC-DC management while providing both charge and discharge capability of an integrated high voltage battery pack. This embodiment can be further optimized by doing power trace simulations of current versus time, showing dynamic FC and battery characteristics and variable load inputs.

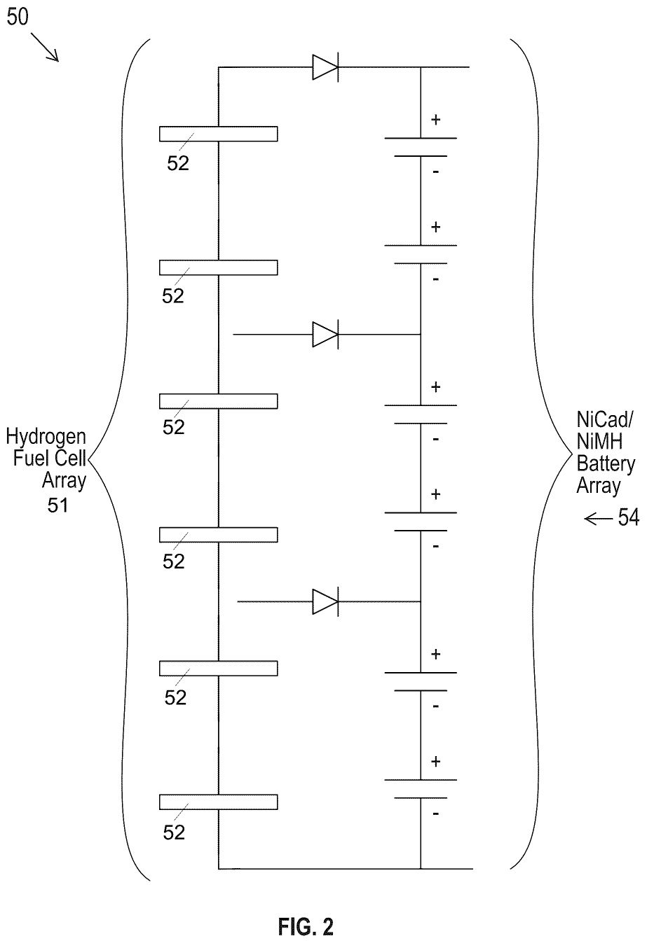

FIG. 2 illustrates a hybrid FC-ES system 50 in accordance with yet another embodiment of the present disclosure comprising three arrays (meant to represent a portion of a multiarray) of two series connected single FCs 52 connected in parallel with a two series connected NiCad/NMC ES battery array 54.

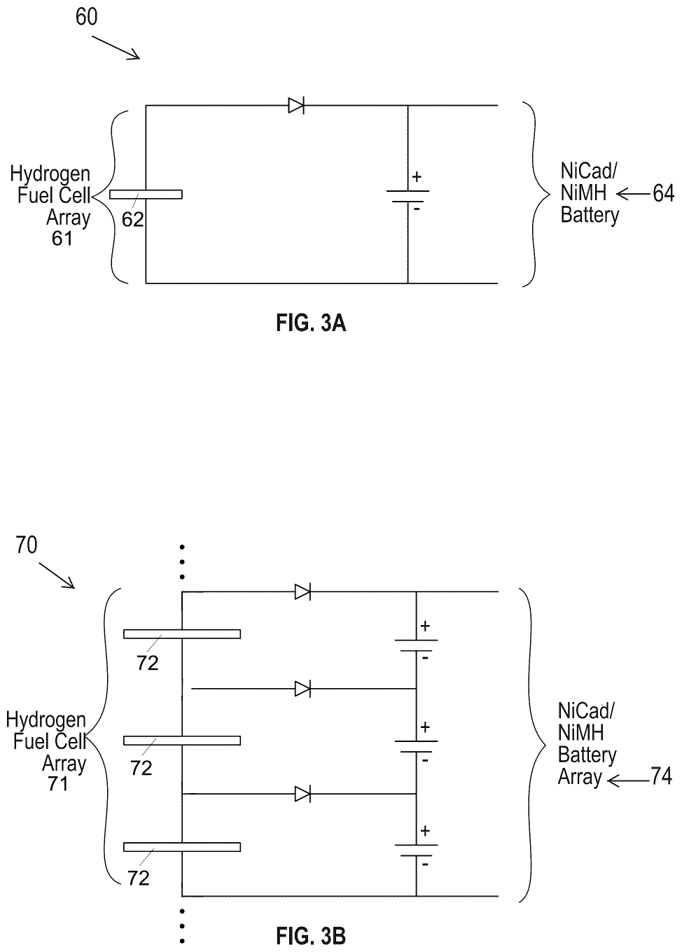

FIG. 3A illustrates a hybrid FC-ES system 60 in accordance with yet another embodiment of the disclosure comprising a single FC 62 connected in parallel to a single NiCad/NMH ES battery 64 as a stand-alone array in accordance with the present disclosure. In the case of incorporating the hybrid FC-ES system 70 of the present disclosure in a device or vehicle requiring more power than a single array, multiple single arrays would be used, as illustrated in FIG. 3B, comprising three arrays (meant to represent a portion of a multiarray) of single series connected FCs 72 connected in parallel with an array 74 of single series connected NiCad/NiMH batteries and other connected cells implied to extend out.

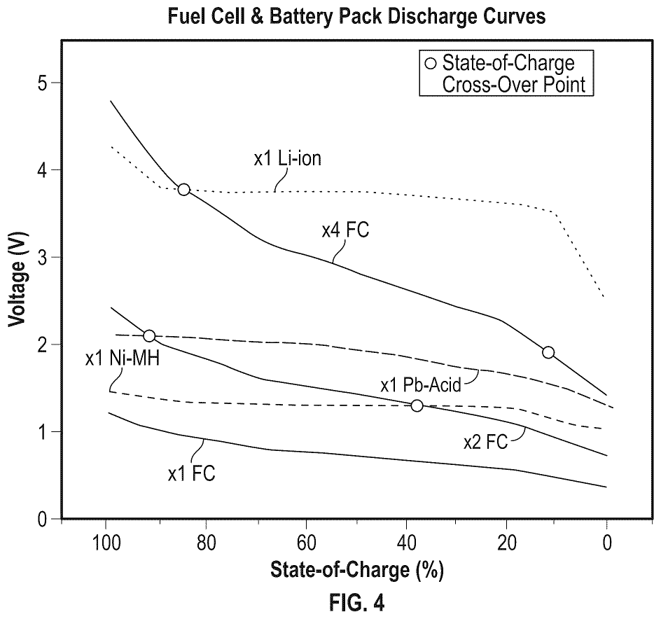

FIG. 4 plots voltage vs. SoC for various hydrogen FC-ES hybrid batteries for various ESs including Li-ion batteries, Pb-acid batteries, and NMH batteries wherein “x1” refers to single stand-alone FC-ES cells, and “x2” refers to two FC-ES cells in series.

The hybrid FC-ES system in accordance with the present disclosure provides several advantages over the prior art. For one, the hybrid FC-ES system provides regulated voltage without the need for power electronics. This significantly reduces the weight, complexity, and cost of an FC-powered system and also eliminates points of potential failure.

Prior to the present disclosure, there were no known direct individual FCs (as opposed to FC stacks) linked to individual ES battery cell assemblies in accordance with the present disclosure.

The present disclosure also permits optimizing SoC regulation capacity by use of hybrid combined series-parallel-connected FC-ES electrical circuit design and battery chemistry.

The present disclosure permits PEMFCs to be operated at essentially constant load which permits achievement of peak efficiency and increase FC-ES life span. Also, by connecting FCs in parallel with ES batteries in accordance with the present disclosure, power demands can be better matched and provide maximum power output when needed, e.g., vehicle acceleration in the case of motor vehicles or when hauling up steep hills or, in the case of an aircraft, during take-off and climb.

Providing hybrid FC-ES arrays in accordance with the present disclosure also permits us to charge batteries when the power produced by the FCs is greater than the amount needed to sustain the forward motion, e.g., during coasting in the case of a motor vehicle or during cruising or dissent in the case of FC powered aircraft. Thus, the FCs can operate more efficiently.

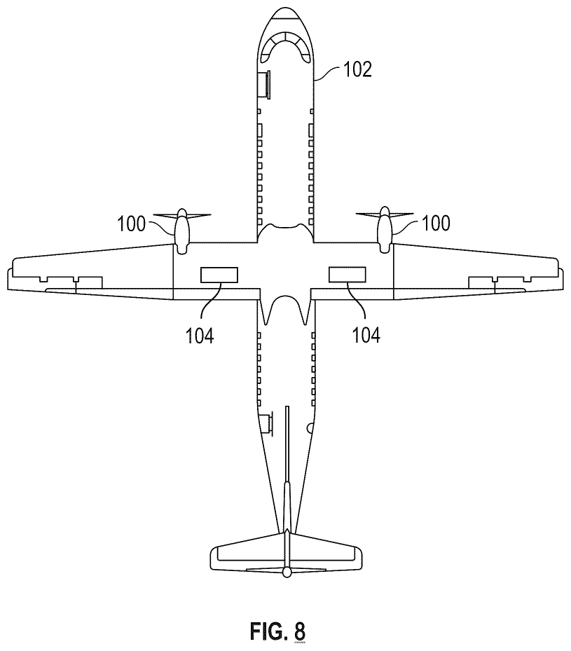

FIG. 8 illustrates an electric motor 100 propelled aircraft 102 powered by a pair of integrated hybrid FC-ES systems 104 in accordance with the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

1. A DC-DC converter-free hybrid fuel cell (FC)-energy storage (ES) system (FC-ES) comprising:
a FC-ES array consisting of:
a single FC; and
a single battery electrically connected to the single FC in parallel, wherein an electrical connection between the single FC and the single battery is free from a DC-DC converter; and
an electric device powered by a voltage from the FC-ES array.

2-8. (canceled)

9. The hybrid FC-ES system of claim 1, wherein the single battery comprises a lithium-ion battery.

10. The hybrid FC-ES system of claim 1, wherein the single battery comprises a Pb-acid battery.

11. The hybrid FC-ES system of claim 1, wherein the single battery comprises a nickel-metal hydride (NiMH) battery.

12. The hybrid FC-ES system of claim 1, wherein the single battery comprises a nickel manganese cobalt (NMC) battery.

13. The hybrid FC-ES system of claim 1, wherein the single FC comprises a hydrogen FC.

14. (canceled)

15. The hybrid FC-ES system of claim 1, wherein the electric device comprises an FC-ES-powered vehicle.

16. The hybrid FC-ES system of claim 15, wherein the vehicle comprises a hydrogen FC powered vehicle.

17. The hybrid FC-ES system of claim 15, wherein the FC-ES-powered vehicle comprises an aircraft.

18. The hybrid FC-ES system of claim 17, wherein the vehicle comprises a hydrogen FC powered airplane.

19. The hybrid FC-ES system of claim 1, wherein the electric device comprises a portable device.

20. The hybrid FC-ES system of claim 19, wherein the portable device comprises a personal electronic device.

21. The electric device of claim 1, a plurality of the FC-ES arrays connected in series with one another.

22. The hybrid FC-ES system of claim 1, wherein the voltage from the FC-ES array powering the electric device is provided by:
the single battery when the voltage is above a state of charge (SoC) cross-over point between the single FC and the single battery; and
the single FC when the voltage is below the SoC cross-over point between the single FC and the single battery.

23. A DC-DC converter-free hybrid fuel cell (FC)-energy storage (ES) system (FC-ES) comprising:
a FC-ES array consisting of:
a single hydrogen FC; and
a single battery electrically connected to the single hydrogen FC in parallel,
wherein an electrical connection between the single FC and the single battery is free from a DC-DC converter; and
a hydrogen FC powered airplane powered by a voltage from the FC-ES array, wherein the voltage is provided by:
the single battery when the voltage is above a state of charge (SoC) cross-over point between the single FC and the single battery; and
the single FC when the voltage is below the SoC cross-over point between the single FC and the single battery.
